(19) United States
(12) Patent Application Publication
(10) Pub. No.: US 2023/0398499 A1
(43) Pub. Date: Dec. 14, 2023

(54) METHOD OF CLEANING ULTRAFILTRATION MEMBRANE MODULE AND MANAGEMENT METHOD OF ULTRAPURE WATER MANUFACTURING SYSTEM USING SAME

(71) Applicant: Samsung Electronics Co., Ltd., Suwon-si (KR)

(72) Inventors: Wuyoung Choi, Suwon-si (KR); Cheolmin Shin, Suwon-si (KR); Seungyong Yang, Suwon-si (KR); Younhaeng Lee, Suwon-si (KR); Changyeol Ham, Suwon-si (KR)

(21) Appl. No.: 18/139,828

(22) Filed: Apr. 26, 2023

(30) Foreign Application Priority Data
May 19, 2022 (KR) 10-2022-0061639

(51) Int. Cl. B01D 65/02; C02F 1/44; B01D 61/14

(52) U.S. Cl. CPC B01D 65/02; C02F 2103/04; B01D 61/145; C02F 1/444

(57) ABSTRACT

A method of cleaning an ultrafiltration membrane module includes installing an ultrafiltration membrane in an ultrafiltration membrane module, supplying deionized water to the ultrafiltration membrane module, and flushing the ultrafiltration membrane module with the deionized water by increasing decreasing a flow rate of the deionized water supplied to the ultrafiltration membrane module.

### CROSS-REFERENCE TO RELATED APPLICATION

This application claims priority under 35 USC § 119 to Korean Patent Application No. 10-2022-0061639, filed on May 19, 2022, with the Korean Intellectual Property Office, the entire disclosure of which is incorporated herein by reference.

### BACKGROUND

### 1. Field

The present inventive concept relates to a method of cleaning an ultrafiltration membrane module and a management method of an ultrapure water manufacturing system using the same.

### 2. Description of Related Art

Ultrapure water is an important solvent widely used in a semiconductor manufacturing process, and is used for various purposes in various processes. An impurity component contained within ultrapure water may act as a risk factor causing product defects in a semiconductor manufacturing process, for example, an exposure process. The impurity component contained in ultrapure water is set as major items of quality of ultrapure water and is managed as a subject of periodic monitoring. Recently, as a degree of integration of semiconductor devices increases and the size thereof decreases, removal of impurities contained in ultrapure water is treated as an important issue in process management.

### SUMMARY

An aspect of the present inventive concept is to provide a method of cleaning an ultrafiltration membrane module for rapidly stabilizing an ultrafiltration membrane module after replacement of an ultrafiltration membrane, and an efficient management method of an ultrapure water management system using the same.

According to an aspect of the present inventive concept, a method of cleaning an ultrafiltration membrane module may be provided. The method of cleaning an ultrafiltration membrane module comprises installing an ultrafiltration membrane in an ultrafiltration membrane module; supplying deionized water to the ultrafiltration membrane module; and flushing the ultrafiltration membrane module with the deionized water by increasing and decreasing a flow rate of the deionized water supplied to the ultrafiltration membrane module.

According to an aspect of the present inventive concept, a management method of an ultrapure water manufacturing system may be provided, the method including selecting a first ultrafiltration membrane module requiring replacement of an ultrafiltration membrane from among a plurality of ultrafiltration membrane modules; replacing an ultrafiltration membrane in the first ultrafiltration membrane module; supplying deionized water to the first ultrafiltration membrane module; flushing the first ultrafiltration membrane module with the deionized water by increasing and decreasing a flow rate of the deionized water supplied to the first ultrafiltration membrane module; measuring a particle concentration of treated water flowing out from the first ultrafiltration membrane module using a particle counter, and when the measured particle concentration is less than or equal to a reference value, stopping the supply of deionized water to the first ultrafiltration membrane module.

According to an aspect of the present inventive concept, a management method of an ultrapure water manufacturing system may be provided, the management method including, in an ultrapure water production line including an ultrafiltration membrane module, closing a first valve connected to a supply unit of the ultrafiltration membrane module; replacing ultrafiltration membranes in the ultrafiltration membrane module; supplying deionized water to the ultrafiltration membrane module by opening a second valve connecting the supply unit of the ultrafiltration membrane module and a deionized water supply unit to each other; flushing the ultrafiltration membrane module with the deionized water by increasing a flow rate of the deionized water supplied to the ultrafiltration membrane module from a first flow rate to a second flow rate; measuring a particle concentration of treated water flowing out from the ultrafiltration membrane module using a particle counter; and when the measured particle concentration is less than or equal to a reference value, stopping the supply of deionized water to the ultrafiltration membrane module in the ultrapure water manufacturing line by closing the second valve, and subsequently opening the first valve.

### BRIEF DESCRIPTION OF DRAWINGS

The above and other aspects, features, and advantages of the present inventive concept will be more clearly understood from the following detailed description taken in conjunction with the accompanying drawings, in which:

FIG. 1 is a block diagram illustrating an ultrapure water manufacturing system according to example embodiments.

FIG. 2 is a diagram illustrating a method of cleaning an ultrafiltration membrane module of an ultrapure water production system or a management method of an ultrapure water manufacturing system according to example embodiments.

FIG. 3 is a flowchart illustrating a method of cleaning an ultrafiltration membrane module of an ultrapure water management system or an ultrapure water manufacturing system according to example embodiments.

FIG. 4 is a graph illustrating a particle concentration measured in filtered water over time after replacing an ultrafiltration membrane in the ultrafiltration membrane module of the ultrapure water manufacturing system according to a first example embodiment of the present inventive concept.

### DETAILED DESCRIPTION

Hereinafter, preferred embodiments of the present inventive concept will be described with reference to the accompanying drawings.

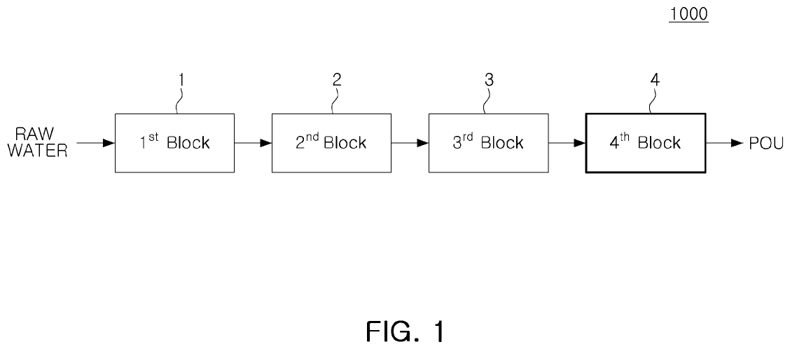

FIG. 1 is a block diagram illustrating an ultrapure water manufacturing system according to example embodiments.

Referring to FIG, 1, an ultrapure water manufacturing system 1000 may include a first block 1, a second block 2, a third block 3, and a fourth block 4. The ultrapure water manufacturing system 1000 supplies, to a point of use (POU), ultrapure water that is generated by removing impurities included in raw water. Raw water may be water that is untreated, partially treated, unfiltered, or partially filtered water. For example, raw water may include a substantial amount of particles, minerals, ions, bacteria, and the like. As used herein, “a point of use (POU)” refers to a place of use of ultrapure water. The raw water may be tap water, well water, underground water, industrial water, and water (recovered water) that is used, recovered and treated in a semiconductor manufacturing plant, or the like.

The first block 1 is a pre-treatment unit, which removes suspended substances in raw water to generate pre-treated water, and supplies the pre-treated water to the second block 2. The first block 1 may be configured by appropriately selecting a sand filtration device, a microfiltration device, or the like, for removing the suspended substances from raw water, for example, and may be configured to further include a heat exchanger, or the like, for controlling a temperature of the raw water as needed. For example, the first block 1 may include at least one of an activated carbon device for removing chlorine (Cl) and suspended solids (SS) with an activated carbon filter, or the like, an ultrafiltration device, and a reverse osmosis (RO) device. Depending on the quality of the raw water, the first block 1 may be omitted.

The second block 2 is a first pure water manufacturing unit or a primary pure water system, and may include at least one of a reverse osmosis device for removing salts, ionic organic substances, and colloidal organic substances in the pre-treated water, a degassing (i.e., deaeration) device (decarboxylation pressure, vacuum deaeration device, membrane deaeration device, and the like), and an ultraviolet oxidation device (TOC-UV). The second block 2 removes bacteria and organic substances in the pre-treated water to generate first pure water, and supplies the first pure water to a third block 3. According to an example embodiment, the reverse osmosis device may be connected in series with two stages to form a two-stage reverse osmosis device. The degassing device is a device for removing dissolved carbon dioxide in the pre-treated water obtained by the reverse osmosis device. The ultraviolet oxidation device is a device having an ultraviolet lamp irradiating an ultraviolet-ray to the pre-treated water received from the previous block, and decomposes and disassembles live cells, bacteria, etc., in the pre-treated water, and sterilizes the pre-treated water.

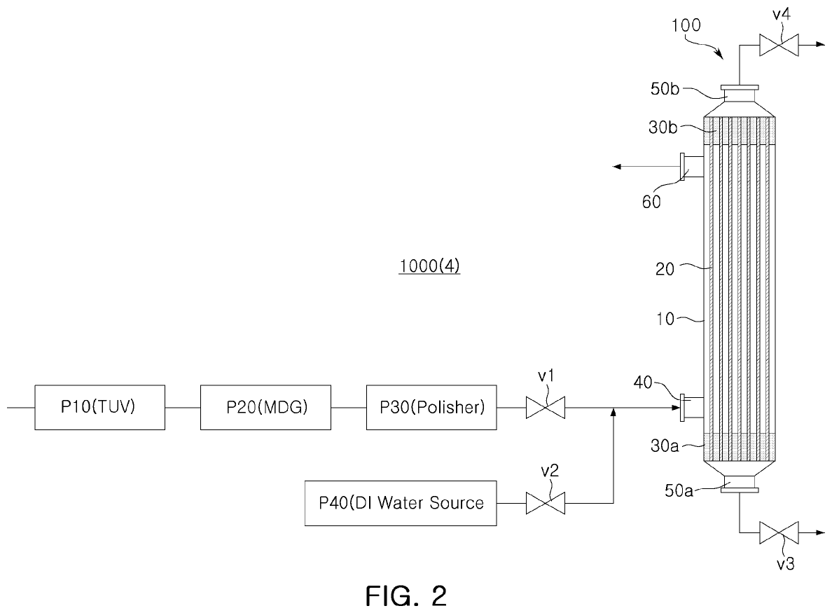

The third block 3 is a second pure water manufacturing unit or sub-system, and may include at least one of an ion exchange device (a cation exchange device, an anion exchange device, a mixed-bed ion exchange device, etc), an ultraviolet oxidation device, and a degassing device. The third block 3 removes the ionic component, non-ionic component, and dissolved gas in the first pure water to manufacture secondary pure water, and supplies the secondary pure water to a fourth block 4. The third block 3 may include a boron removal device for removing boron. This will be further described with reference to FIG. 2.

The fourth block 4 is a polishing unit, and may further include at least one of a heat exchanger, an ultraviolet oxidation device, an ion exchange device, a degassing device, and an ultrafiltration device, if necessary. The polishing device may include an ion exchange resin, and may be configured to remove ionic substances from the water to be treated (e.g., the secondary pure water). In the fourth block 4, a trace amount of organic substance, in the secondary pure water is oxidized and decomposed with ultraviolet rays using an ultraviolet oxidizer to remove the same. The water may then pass through an ultrafiltration device to manufacture (i.e., produce) final semiconductor grade ultrapure water.

The first to third blocks 1, 2, and 3 may include processing stages for manufacturing pure water, and the fourth block 4 may include a polishing process for manufacturing ultrapure water. Pure water (e.g., “first pure water” and “secondary pure water”) may have a resistivity at 25° C. of approximately 1.0-10.0 MΩ*cm. Ultrapure water may have a resistivity at 25° C. of more than 18 MΩ* cm or close to 18.25 MΩ* cm.

FIG. 2 is a diagram illustrating a method for cleaning an ultrafiltration membrane module of an ultrapure water manufacturing system or a management method of an ultrapure water manufacturing system according to example embodiments. FIG. 2 schematically illustrates an ultrapure water manufacturing line provided by the fourth block 4 of the ultrapure water manufacturing system 1000 of FIG. 1.

Referring to FIG. 2, the ultrapure water manufacturing line of the ultrapure water manufacturing system 1000 may include an ultraviolet oxidation device P10, a membrane degassing device P20, a polishing device P30, and an ultrafiltration membrane module 100. The ultrapure water manufacturing system 1000 may further include a deionized water supply unit P40 for supplying deionized water to the ultrafiltration membrane module 100 when the ultrafiltration membrane module 100 is cleaned. The ultrapure water manufacturing system 1000 may further include valves v1, v2, v3, and v4 for opening and closing piping lines connected to the ultrafiltration membrane module 100.

The ultraviolet oxidation device P10 has, for example, an ultraviolet lamp capable of irradiating ultraviolet rays having a wavelength of about 185 nm, and oxidatively decomposes total organic carbon (TOC) in water to be treated by irradiating ultraviolet rays to the water to be treated by the ultraviolet lamp. By ultraviolet rays, water is decomposed to generate OH radicals, and the OH radicals oxidatively decompose organic matter contained in the water to be treated.

The membrane degassing device P20 may remove carbon dioxide and/or oxygen in the water to be treated. The membrane degassing device P20 is a device capable of separating gas dissolved in a liquid using a hollow fiber membrane. The membrane degassing device P20 may include a hydrophobic membrane such as porous polypropylene (PP) or polymethylpentene (PMP) as a material of the hollow fiber membrane.

The polishing device P30 may include an ion exchange resin, and may remove ionic substances from the water to be treated. The water to be treated eluted from the polishing device P30 may be supplied to the ultrafiltration membrane module 100 through a first valve v1.

The ultrafiltration membrane module 100 may include a housing 10, a plurality of ultrafiltration membranes 20 in the housing 10, adhesive resins 30a and 30b installed and fixed at both ends of the ultrafiltration membranes 20 in the housing 10, a supply unit 40 for supplying water to be treated, outlets 50a and 50b for discharging the water to be treated, and a concentrated water outlet 60 for discharging concentrated water.

The housing 10 may connect with the supply unit 40, the outlets 50a and 50b, and the concentrated water outlet 60. Concentrated water may be ultrapure water whose particle density is increased because the particles do not pass through the plurality of ultrafiltration membranes and may flow out through the concentrated water outlet 60.

The water to be treated, received by the supply unit from the polishing device 30, may flow from the supply unit 40 and pass through the plurality of ultrafiltration membranes 20. The outlets 50a and 50b may connect with upper and lower portions of the housing 10, respectively. Water to be treated from which the particles are removed (i.e., ultrapure water) may be discharged through the outlets 50a and 50b, and the ultrapure water may be supplied to a point of use POU (i.e., a place where ultrapure water is used).

The plurality of ultrafiltration membranes 20 may constitute a hollow fiber membrane bundle. As a material constituting the plurality of ultrafiltration membranes 20, for example, a polymer material such as polyvinylidene fluoride, polyethylene, polypropylene, polysulfone, polyethersulfone, polyphenyiene oxide, polyacrylonitrile, cellulose or cellulose derivatives, and polyvinyl alcohol and a composite material thereof, or an inorganic material such as alumina and zirconia, may be used.

The adhesive resins 30a and 30b may fix the plurality of ultrafiltration membranes 20. The adhesive resins 30a and 30b may include a first adhesive resin 30a for fixing lower portions of the plurality of ultrafiltration membranes 20 and a second adhesive resin 30b for fixing upper portions of the plurality of ultrafiltration membranes 20. The upper and lower portions of the housing 10 may be sealed by the adhesive resins 30a and 30b, and end portions of the ultrafiltration membranes 20 may be exposed from (e.g., not covered by) the adhesive resins and 30b. The adhesive resins 30a and 30b may be formed of, a polymer material, for example, an epoxy resin, an urethane resin, a silicone resin, polyvinylidene fluoride, polyethylene, polypropylene, polysulfone, polyethersulfone, polyphenylene oxide, polyvinyl chloride, polycarbonate, an ABS resin, and the like, an inorganic material such as alumina or zirconia, or a metal material such as stainless steel or aluminum.

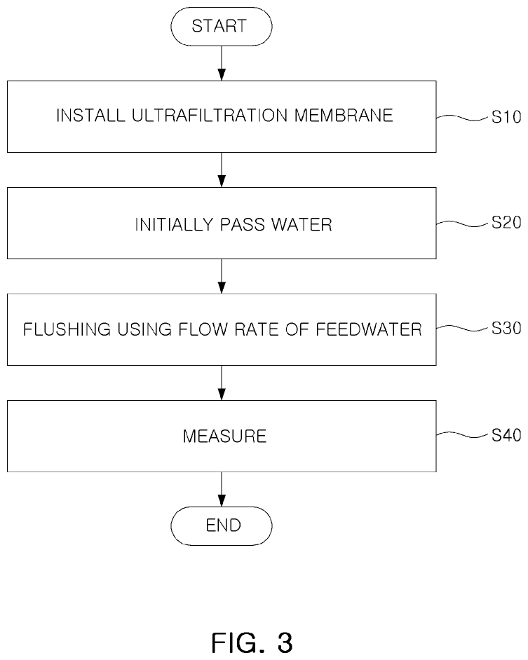

Prior to operation of the ultrapure water manufacturing system, that is, prior to manufacturing ultrapure water, as illustrated in FIG. 3 below, an operation of installing an ultrafiltration membrane (S10), an operation of initially passing water (S20), an operation of flushing (S30) using control of a flow rate of feedwater, and an operation of measuring (S40) may be performed to wash the ultrafiltration membrane module 100 of FIG. 2. Hereinafter, a method of cleaning the ultrafiltration membrane module 100 or a management method of an ultrapure water manufacturing system will be described with reference to FIG. 3.

FIG. 3 is a flowchart illustrating a method of cleaning an ultrafiltration membrane module of an ultrapure water manufacturing system or a management method of an ultrapure water manufacturing system according to example embodiments.

Referring to FIG. 3, the method of cleaning of the ultrafiltration membrane module 100 of the ultrapure water manufacturing system 1000 or the management method of the ultrapure water manufacturing system 1000 may include an operation of installing an ultrafiltration membrane (S10), an operation of initially passing water (S20), an operation of flushing (S30) using a control of a flow rate of feedwater, and an operation of measuring (S40).

In the operation of installing an ultrafiltration membrane (S10), the ultrafiltration membrane 20 may be installed in the housing 10 without directly handling a nozzle of the ultrafiltration membrane module 100, for example, pipes connected to the supply unit 40, the outlets 50a and 50b, and the concentrated water outlet 60. The operation of installing an ultrafiltration membrane 20 (S10) may include replacing a first (e.g., old or existing) ultrafiltration membrane 20 with a second (e.g., new) ultrafiltration membrane 20 or installing for the first time an ultrafiltration membrane 20 into the housing 10. In the operation of replacing the ultrafiltration membrane 20, a gasket used in a housing 10 may be replaced with a new gasket and the adhesive resins 30a and 30b may also be replaced.

Before the operation of installing the ultrafiltration membrane (S10), an ultrafiltration membrane module requiring replacement of the ultrafiltration membrane 20 may be selected first. When the replacement of the ultrafiltration membrane 20 is required, first, a first valve v1 connected to the supply unit 40 of the ultrafiltration membrane module 100 in the ultrapure water manufacturing line may be closed.

In the operation of installing the ultrafiltration membrane (S10), particles or gas may flow into the ultrafiltration membrane module 100. The particles or the gas may be generated in the ultrafiltration membrane 20 itself during the manufacturing process of the ultrafiltration membrane 20, or may flow thereinto from the outside when the ultrafiltration membrane 20 is replaced. The particles or the gas need to be removed quickly and efficiently prior to manufacturing ultrapure water.

In the operation of initially passing water into the ultrafiltration membrane module 100 subsequent to replacing/installing the ultrafiltration membrane 20 (S20), deionized water supplied by a deionized water (DI) water supply unit (P40) may be flowed into the ultrafiltration membrane module 100. Deionized water may be suppled into the housing 10 of the ultrafiltration membrane module 100 by opening a second valve v2 connecting the supply unit 40 of the ultrafiltration membrane module 100 and the deionized water supply unit P40 to each other. After the operation of initially passing water (S20), a flow rate of the deionized water can be adjusted with rated operation. While the deionized water is being supplied, vibrations may be applied to at least a portion of the housing 10 from the outside. By applying the vibrations, vibrational energy may be applied to the particles attached to an inner surface of the housing 10, whereby the particles may be removed by being peeled from the inner surface of the housing 10.

The flushing operation (S30) using control of the flow rate of the feedwater may be performed under basic conditions that do not exceed specifications of the ultrafiltration membrane 20. The basic conditions may be set as pressure conditions according to the type of the ultrafiltration membrane 20 used, a maximum filtration amount of the ultrafiltration membrane, a recovery rate of concentrated water, a maximum flow rate, and the like. For example, the ultrafiltration membrane 20 may be, for example, a membrane developed by Asahi Kasei, such as models OLT-6036SA, OLT-6036SAN, OLT-6036VA, OLT-6036VAN, or the like. The ultrafiltration membrane module 100 may be flushed in consideration of conditions required for operation (e.g., as set forth by a manufacturer or developer) for each product (e.g., a temperature of feedwater, a maximum pressure on inner and outer surfaces of the membrane, a maximum pressure on a side of the feedwater, a maximum pressure on a side of filtered water, etc).

In the flushing operation (S30) using the control of the flow rate of the feedwater, a flow rate of feedwater flowing into the ultrafiltration membrane module 100 may be increased or decreased. The feedwater used in the flushing operation (S30) may be deionized water (DI water) (e.g., the deionized water from the deionized water supply unit P40). Depending on the type (e.g., manufacturer/developer and model) of the ultrafiltration membrane 20, cool deionized water in a temperature range of about 0° C. to about 25° C. may be used as the deionized water, or hot deionized water in a temperature range of about 50° C. to about 100° C. may be used.

The particles or the gas may be relatively small-sized particles or gas remaining in the housing 10 without being removed in the operation of initially passing water (S20). In the flushing operation (S30) using the flow rate of feedwater control, a flow rate of feedwater may be increased from 0 m³/h to an optimal flow rate (m³/h) or more. For example, the flow rate of feedwater may be increased from the rated flow rate (m³/h) to the optimal flow rate (m³/h) or more, and then decreased back to the rated flow rate (m³/h). When the flow rate of feedwater reaches the optimal flow rate (m³/h), particles or gas having a relatively small size remaining in the housing 10 can be effectively removed in a short time. In some example embodiments, the operation of increasing or decreasing the flow rate of feedwater may be performed multiple times.

In the measuring operation (S40), a concentration of particles or gas contained in an effluent flowing out from the ultrafiltration membrane module 100 may be measured using a particle counter, The particle counter may be, for example, a liquid particle counter, such as the UDI® 50 liquid particle counter device that measures particles having a size of about 50 nm or more. When the measured concentration of the particle is less than or equal to a reference value, the method of cleaning the ultrafiltration membrane module 100 may be terminated. For example, by closing the second valve v2, and opening the first valve v1, in the ultrapure water manufacturing line, ultrapure water can be manufactured by initiating water passage of the ultrafiltration membrane module 100. The reference value may be about 200 pcs/L. If the measured particle concentration exceeds the reference value, the flushing operation (S30) using the flow rate of feedwater control may be performed again. For example, the flushing operation (S30) of the ultrafiltration membrane module 100 may be repeatedly performed until the measured particle concentration is equal to or less than the reference value. Terms such as “about” or “approximately” may reflect amounts, sizes, orientations, or layouts that vary only in a small relative manner, and/or in a way that does not significantly alter the operation, functionality, or structure of certain elements. For example, a range from “about 0.1 to about 1” may encompass a range such as a 0%-5% deviation around 0.1 and a 0% to 5% deviation around 1, especially if such deviation maintains the same effect as the listed range.

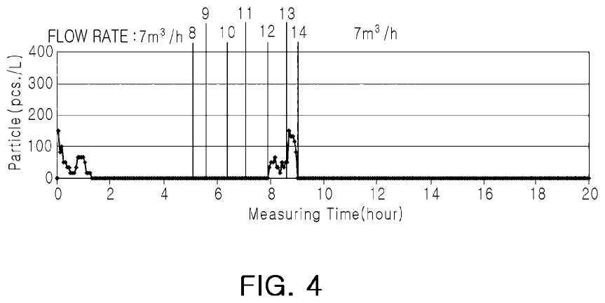

FIG. 4 is a graph illustrating a particle concentration measured in filtered water over time after replacing an ultrafiltration membrane in an ultrafiltration membrane module in an ultrapure water manufacturing system according to a first embodiment of the present inventive concept.

Operating conditions of the ultrafiltration membrane module 100 of the first embodiment of the present inventive concept are as follows.

A maximum filtration amount of feedwater supplied through a supply unit 40 is not to exceed about 16 m³/h, a recovery rate of concentrated water discharged through a concentrated water outlet 60 is about 90% to about 99%, and a maximum flow rate of concentrated water is about 1 m³/h. When an increase in a temperature or a decrease in a temperature is required, the temperature is increased or decreased at about 5° C./min or less, in order to prevent damage to the ultrafiltration membrane module 100 due to thermal expansion and leakage of the water to be treated due to this. The increase in the temperature or the decrease in the temperature may be performed by providing a separate heat exchanger connected to a rear end of a deionized water supply unit 140.

After installing the ultrafiltration membrane (S10) and passing through an initial water passage operation (S20), a flushing operation (S30) using a flow rate of feedwater control may be performed. In the flushing operation (S30), a recovery rate of concentrated water was kept constant in a range of about 90% to 99%, and a flow rate of feedwater was changed. For example, the flow rate of feedwater was increased from a rated flow rate of about 7 m³/h to about 14 m³/h. When feedwater is suppled at a flow rate of feedwater of about 13 m³/h, a flow rate flowing through two outlets 50a and 50b was about 6.5 m³/h, respectively, and a performing time of the flushing operation (S30) was 1.5 hours or more.

After performing the flushing operation (S30) for about 1.5 to about 5 hours, as a result of checking a concentration of particles measured in filtered water from the ultrafiltration membrane module 100 using a particle counter UDI-50, if the concentration was 200 pcs./L or less, the flushing operation is terminated. If the concentration of particles exceeds 200 pcs./L, an operation of increasing or decreasing the flow rate flow rate is performed again.

According to a first embodiment of the present inventive concept, it was confirmed that the particle or the gas remaining in the ultrafiltration membrane module 100 was removed in a range in which a flow rate of feedwater is about 12 m³/h to about 14 m³/h during a process of increasing the flow rate of feedwater. By performing the flushing operation (S30) of the ultrafiltration membrane module 100 by increasing or decreasing the flow rate of feedwater, the particle or the gas remaining in the ultrafiltration membrane module 100 may be efficiently removed in a short amount of time.

### Second Embodiment

According to the first embodiment of FIG. 4, it was confirmed that an optimal flow rate for removing particles or gas is about 12 m³/h to about 14 m³/h, when water passes through the outlets in both directions at the same flow rate, but when a permeation flow rate supplied to at least one ultrafiltration membrane module among the plurality of ultrafiltration membrane modules is less than the optimal flow rate, if a permeate flow rate of about 6.0 m³/h to 7.0 m³/h or more, which is 50% of the optimal flow rate, may be obtained, it is possible to remove the particles or the gas by the following method, which is a second embodiment.

The flow rate of water flowing in the ultrafiltration membrane module 100 may be changed by adjusting a third valve v3 and a fourth valve v4 connected to the outlets 50a and 50b. For example, the flushing operation (S30) may include a first flushing operation of passing water at a flow rate of about 85% to about 95% of the flow rate of feedwater from the ultrafiltration membrane module 100 through the first outlet 50a, and passing water at a flow rate of about 0% to about 10% of the flow rate of feedwater from the ultrafiltration membrane module 100 through the second outlet 50b, and a second flushing operation of passing water at a flow rate of about 0% to about 10% of the flow rate of feedwater from the ultrafiltration membrane module 100 through the first outlet 50a, and passing water at a flow rate of about 85% to about 95% of the flow rate of feedwater from the ultrafiltration membrane module 100 through the second outlet 50b, after the first flushing operation.

In the first flushing operation, without completely closing the fourth valve v4, a small amount of the feedwater is discharged through the second outlet 50b, thereby preventing accumulation of dissolved oxygen in the feedwater due to stagnation of the feedwater in the ultrafiltration membrane module 100. Similarly, in the second flushing operation, without completely closing the third valve v3, a small amount of the feedwater is discharged through the first outlet 50a, thereby preventing accumulation of dissolved oxygen in the feedwater due to stagnation of the feedwater in the ultrafiltration membrane module 100,

When each of the first flushing operation and the second flushing operation is performed, since a small amount of feedwater is passed through one of the outlets 50a and 50b, a flow of feedwater passing through the other thereof may be increased. In this case, since a flow rate per unit area of the feedwater passing through the ultrafiltration membranes 20 can be increased, the flow rate per unit area at the same or similar level as when passing the feedwater through in both directions as in the first embodiment may be obtained. Therefore, by performing each of the first flushing operation and the second flushing operation, it is possible to efficiently remove particles or gases remaining in the ultrafiltration membrane module 100 in a short period of time, even if the flow rate of feedwater is insufficient.

For example, when the flow rate of the feedwater is about 7.2 m³/h, first, a permeated water amount of the first outlet 50a may be about 6.5 m³/h, and a permeated water amount of the second outlet 50b may be about 0.34 m³/h. The flushing time may be at least about 1.5 hours. Next, the upper and lower flow rates of the ultrafiltration membrane module 100 may be reversed. For example, the permeated water amount of the first outlet 50a may be about 0.34 m³/h, and the permeated water amount of the second outlet Sob may be about 6.5 m³/h. By repeating this process, it is possible to efficiently remove particles or gases in the ultrafiltration membrane module 100 in a short time.

As set forth above, according to aspects of the present inventive concept, a method of cleaning an ultrafiltration membrane module capable of quickly stabilizing the ultrafiltration membrane module after replacing an ultrafiltration membrane and an efficient management method of an ultrapure water manufacturing system using the same may be provided.

While example embodiments have been shown and described above, it will be apparent to those skilled in the art that modifications and variations could be made without departing from the scope of the present inventive concept as defined by the appended claims.

What is claimed is:

1. A method of cleaning an ultrafiltration membrane module, the method comprising:
installing an ultrafiltration membrane in an ultrafiltration membrane module;
supplying deionized water to the ultrafiltration membrane module; and
flushing the ultrafiltration membrane module with the deionized water by increasing and decreasing a flow rate of the deionized water supplied to the ultrafiltration membrane module.

2. The method of cleaning an ultrafiltration membrane module of claim 1, wherein flushing the ultrafiltration membrane module with the deionized water is an operation of removing particles or gas in the ultrafiltration membrane module.

3. The method of cleaning an ultrafiltration membrane module of claim 2, wherein the particles or the gas are removed during a process in which the flow rate of the deionized water flowing into the ultrafiltration membrane module is increased.

4. The method of cleaning an ultrafiltration membrane module of claim 3, wherein the flow rate of the deionized water is increased or decreased in a range of about 7 m³/h to about 14 m³/h.

5. The method of cleaning an ultrafiltration membrane module of claim 4, wherein the particles or gas in the ultrafiltration membrane module are removed in a range in which the flow rate of the deionized water is about 12 m³/h to about 14 m³/h.

6. The method of cleaning an ultrafiltration membrane module of claim 1, wherein, while supplying deionized water to the ultrafiltration membrane module, vibrations are applied to the ultrafiltration membrane module.

7. The method of cleaning an ultrafiltration membrane module of claim 1, wherein the ultrafiltration membrane module comprises a first outlet and a second outlet, and flushing the ultrafiltration membrane module comprises a first flushing operation of discharging a flow rate of about 85% to 95% of the flow rate of the deionized water from the ultrafiltration membrane module through the first outlet, and discharging a flow rate of about 0% to 10% of the flow rate of the deionized water from the ultrafiltration membrane module through the second outlet.

8. The method of cleaning an ultrafiltration membrane module of claim 7, wherein flushing the ultrafiltration membrane module further comprises a second flushing operation, after the first flushing operation, of discharging a flow rate of about 0% to 10% of the flow rate of the deionized water from the ultrafiltration membrane module through the first outlet, and discharging a flow rate of about 85% to 95% of the flow rate of the deionized water from the ultrafiltration membrane module through the second outlet.

9. A management method of an ultrapure water manufacturing system, the method comprising:
selecting a first ultrafiltration membrane module requiring replacement of an ultrafiltration membrane from among a plurality of ultrafiltration membrane modules:
replacing an ultrafiltration membrane in the first ultrafiltration membrane module;
supplying deionized water to the first ultrafiltration membrane module;
flushing the first ultrafiltration membrane module with the deionized water by increasing and decreasing a flow rate of the deionized water supplied to the first ultrafiltration membrane module;
measuring a particle concentration of treated water flowing out from the first ultrafiltration membrane module using a particle counter; and
when the measured particle concentration is less than or equal to a reference value, stopping the supply of deionized water to the first ultrafiltration membrane module.

10. The management method of an ultrapure water manufacturing system of claim 9, wherein flushing the first ultrafiltration membrane module with the deionized water is an operation of removing particles or gas entered into the first ultrafiltration membrane module when replacing the ultrafiltration membrane.

11. The management method of an ultrapure water manufacturing system of claim wherein, in a process in which the flow rate of the deionized water flowing into the first ultrafiltration membrane module is increased, the particles or the gas are removed.

12. The management method of an ultrapure water manufacturing system of claim 9, wherein, when the measured particle concentration exceeds a reference value, flushing the first ultrafiltration membrane module with the deionized water is performed again.

13. The management method of an ultrapure water manufacturing system of claim 9, wherein the deionized water is deionized water having a temperature in a range of about 0° C. to about 25° C.

14. The management method of an ultrapure water manufacturing system of claim 9, wherein the particle counter is a liquid particle counter configured to measure particles of about 50 nm or more.

15. The management method of an ultrapure water manufacturing system of claim 9, wherein the reference value is about 200 pcs./L.

16. A management method of an ultrapure water manufacturing system, the method comprising:
in an ultrapure water manufacturing line including an ultrafiltration membrane module, closing a first valve connected to a supply unit of the ultrafiltration membrane module;
replacing ultrafiltration membranes in the ultrafiltration membrane module;
supplying deionized water to the ultrafiltration membrane module by opening a second valve connecting the supply unit of the ultrafiltration membrane module and a deionized water supply unit to each other;
flushing the ultrafiltration membrane module with the deionized water by increasing a flow rate of the deionized water supplied to the ultrafiltration membrane module from a first flow rate to a second flow rate;
measuring a particle concentration of treated water flowing out from the ultrafiltration membrane module using a particle counter; and
when the measured particle concentration is less than or equal to a reference value, stopping the supply of deionized water to the ultrafiltration membrane module in the ultrapure water manufacturing line by closing the second valve, and subsequently opening the first valve.

17. The management method of an ultrapure water manufacturing system of claim 16, wherein flushing the ultrafiltration membrane module with the deionized water is an operation of removing particles or gas remaining entered into the ultrafiltration membrane module when replacing the ultrafiltration membranes, and
when the flow rate of the deionized water reaches the second flow rate, the remaining particles or the gas are removed.

18. The management method of an ultrapure water manufacturing system of claim 16, wherein the ultrafiltration membrane module comprises a housing for accommodating the ultrafiltration membranes, first and second adhesive resins for fixing upper and lower portions of the ultrafiltration membranes in the housing, respectively, first and second outlets respectively communicating with upper and lower portions of the housing, and a concentrated water outlet for discharging concentrated water.

19. The management method of an ultrapure water manufacturing system of claim 18, wherein a maximum filtration amount of deionized water supplied through the supply unit of the ultrafiltration membrane module does not exceed about 16 m³/h, and
the flow rate of the deionized water is increased while maintaining a recovery rate of the concentrated water discharged through the concentrated water outlet to be in a range of about 90% to about 99%.

20. The management method of an ultrapure water manufacturing system of claim 16, wherein while supplying deionized water to the ultrafiltration membrane module, vibrations are applied to the ultrafiltration membrane module.
